(19) United States
(12) Patent Application Publication
(10) Pub. No.: US 2023/0104437 A1
(43) Pub. Date: Apr. 6, 2023

(54) HIGH-ENERGY ELECTRODES WITH CONTROLLED MICROSTRUCTURES FOR ELECTROCHEMICAL DEVICES AND METHOD FOR PREPARING THE SAME

(71) Applicant: Ohio State Innovation Foundation, Columbus, OH (US)

(72) Inventors: Jung Hyun KIM, Columbus, OH (US); Lalith RAO, Columbus, OH (US); Jay SAYRE, New Albany, OH (US)

(21) Appl. No.: 17/909,647

(22) PCT Filed: Mar. 8, 2021
(86) PCT No.: PCT/US21/21361

§ 371 Date: Sep. 6, 2022

Related U.S. Application Data
(60) Provisional application No. 62/986,044, filed on Mar. 6, 2020.

(51) Int. Cl. H01M 4/66; H01M 4/137; H01M 4/40; H01M 4/62; H01M 10/0525

(52) U.S. Cl. CPC H01M 4/667; H01M 4/137; H01M 4/40; H01M 4/622; H01M 4/661; H01M 10/0525; H01M 2004/021

(57) ABSTRACT

Disclosed herein are electrodes for electrochemical devices and methods of making the electrodes. The electrodes include an electrode body comprising a plurality of channels wherein at least a portion of the channels extend from the first surface to the second surface of the electrode body. In the methods of making the electrodes, a combination of binder chemistry, solid loading, dispersant, types of carbon network, substrate surface modification, and drying temperature and time can be used to control the channel size and density.

### CROSS REFERENCE TO RELATED APPLICATIONS

This application claims the benefit of priority to U.S. Provisional Application No. 62/986,044, filed Mar. 6, 2020, which is incorporated by reference herein in its entirety.

### FIELD

This application relates to electrochemical devices, particularly devices produced with controlled microstructure suitable for energy storage.

### BACKGROUND

Conventional electrodes for Li-ion batteries are prepared as thin layers (70-100 microns) to meet the power requirements of automotive applications. However, using thin electrodes compromises energy densities of battery cells due to increasing weight and volume of inactive components such as current collectors and a separator.

Thick (or 3D) electrodes have better active material utilization ratio and hence give better energy densities. Increasing electrode thickness beyond 100 μm is challenging in Li-ion batteries due to limited Li-ion transport via liquid electrolyte and a consequent inhomogeneous electrochemical reaction, which accelerates local degradation of electrodes during repeated battery cycling (i.e., capacity fading). Further, due to insufficient electrolyte in the hulk of the electrode, rate capability is compromised To address these challenges, recent research and development effort has focused on developing thick-electrode design and processing methods that can offer both high power and energy for Li-ion batteries. For example, various methods have been suggested in literature which include 3D electrode foams, magnetic templating, freeze-casting and spark plasma sintering.

One promising approach is controlling the 3-D pore structure of thick electrodes with a goal to minimize tortuosity and thereby advance Li-ion electrolyte transport. However, this new electrode design cannot be realized by using conventional battery fabrication. There is a need for a process which is applicable to wide range of thickness, materials and which gives good electrode stability, porosity, material loading and adopting advanced binders are required. The systems and method disclosed herein address these and other needs, particularly, provides processing technique to produce thick electrodes with enhanced rate capability.

### SUMMARY

Disclosed herein are systems and methods for improving access of electrolytes in bulk of thick electrodes. The systems and methods can be realized by producing channels (cracks) in the electrode body. The size and density of the channels can be controlled during fabrication of the electrodes. For example, vertical channels can be produced that run through the entire thickness of the electrode. As the thickness of the electrode increases, these channels form a pathway for fast ionic transport leading to higher rate capability and homogeneous electrochemical reactions of active materials across the electrodes. By controlling the channel formation and channel density, optimum battery performances can be achieved. In the methods of making the electrodes, a combination of binder chemistry, solid loading (amount of dry powders in water), dispersant, types of carbon network, substrate surface modification, and drying temperature and time can be used to control the channel size and density. For example, styrene butadiene rubber (SBR) can be used to give good dispersion and cracking characteristics. The amount of SBR can be optimized to get the desired cracking while preventing capacity degradation. Polyacrylic acid (PAA) can act as a binder and thickening agent. To improve the dispersion and wetting characteristics of the electrode slurry, tertiary butanol can be used as an additive in the electrode slurry. This reduces the surface tension of the slurry and decreases the volatility of the solvent. Adding tert-butanol also gives some control over channel formation. Electrodes thus obtained are stable mechanically, meaning it does not delaminate from the current collector surface.

Apart from creating vertical channels, some other aspects disclosed herein during electrode fabrication include maintaining good electrode stability during active material loading and porosity, improving interfacial contact between electrode slurry and current collector, enhancing carbon network (dispersion) for electronic conductivity within the thick electrode, optimizing binder chemistry and content for good adhesion between active material and carbon which affects the porous structures in thick electrodes, and optimizing solvent properties in slurries using additives to control surface energies and volatilities.

In certain aspects, the electrodes disclosed herein are for use in an electrochemical device, the electrode comprising an electrode body having a first surface and second surface opposite the first surface, wherein the second surface of the electrode body is affixed to a current collector, wherein the electrode body comprises a plurality of channels and at least a portion of the channels extend from the first surface to the second surface of the electrode body, and wherein the electrode body has an average thickness (distance from the first surface to the second surface of the electrode body) of at least about 70 μm. The electrochemical device can be an energy storage device such as a lithium-ion battery, a lithium-sulfur battery, a solid state battery, a fuel cell, or an actuator, preferably the electrochemical device is a lithium-ion battery.

The electrode body can have an average thickness of at least about 200 μm, such as from about 200 μm to about 500 μm, from about 200 μmm to about 400 μm, or from about 200 μm to about 300 μm. At least a portion of the channels present in the electrode body has an average length of at least about 10 μm, at least about 100 μm, at least about 200 μm, from about 10 μm to about 500 μm, or from about 50 μm to about 500 μm. The plurality of channels can be isolated from each other and/or interconnected The plurality of channels can be present in an amount (crack volume (Cr)) of 10 vol % or greater, such as from 10-60%, preferably from 10-30%, based on the volume of the electrode. The electrode body may further comprise pores, wherein the pores can have a porosity volume of 30% or greater, 35% or greater, 40% or greater, from 20% to 60%, or from 30% to 40% , based on the volume of the electrode.

The electrode body comprises a solid binder. The binder can include a conducting polymer that is solvent soluble, such as a water soluble polymer. For example, the binder can include a conducting polymer such as polyacrylic acid (PAA), styrene-butadiene rubber (SBR), carboxylic acid and/or carboxylate polymers, polysaccharides, maleated polymers, fumarated polymers, ethylenically unsaturated acid polymers, carboxylated polyvinyl chloride, polyvinyl alcohol or copolymers with vinyl alcohol monomer units, polyundecylenol, copolymers of olefin and undecylenol, copolymers of olefin and undecylenic acid, ethylenically unsaturated alcohol polymers, phenoxy resins, cyclodextrin, hydroxypropyl cyclodextrin, hydroxyethyl cyclodextrin, copolymers thereof, crosspolymers thereof, alkali and/or alkaline earth metal salts thereof, or esters thereof. Preferably, the binder comprises polyacrylic acid and styrene-butadiene rubber (SBR) in a weight ratio from 1:4 to 4:1, such as from 2:1 to 4:1. In certain embodiments, the binder does not comprise a fluoride-containing polymer such as a polyvinylidene fluoride.

The electrode also includes a conductive additive. The conductive additive can be selected from one or more forms of carbons, such as carbon black, graphite, carbon nanofibers, carbon microfibers, or a combination thereof, in some examples, the conductive additive includes at least two forms of carbons, such as graphite and carbon nanofibers. The conductive additive can be present in an amount of from 3% to 20% from 3% to 10% by weight of the electrode body.

The electrode body also includes an electroactive material. The electroactive material, can include a lithium based electroactive material, such as LiFePO₄(LFP). The electroactive material can be present in an amount from 50% to 96% or from 60% to 85% by weight of the electrode body.

The electrode body can include the electroactive material, the binder, and conductive additive in a weight ratio from 60-95:2.5-10:2.5-30.

The electrode body may further comprise an electrolyte, wherein the electrolyte is present in the plurality of channels. Examples of electrolytes include an alkali-salt dissolved in an organic/aqueous solvent, preferably LiPF₆ in a mixture of linear carbonates or ring carbonates.

The current collector as described herein can include a metal current collector. For example, the current collector can include Cu and/or Al, and can be selected from Cu or Al foils with or without carbon-coating.

The electrodes described herein can exhibit a rate capability (area specific capability) of at least 2.2 mAh/cm², at least 3.3 mAh/cm², or at least 5.8 mAh/cm²at a C-rate of up to 1C.

Methods for manufacturing the electrodes described herein are also disclosed. The methods can include forming an electrode body by mixing an electroactive material, a conductive additive, a binder, a dispersant, and a solvent to form a slurry, depositing the slurry on a surface of a current collector; and drying the slurry at an elevated temperature for a sufficient time to induce formation of a plurality of channels in the electrode body. As described herein, the binder comprises a solvent soluble polymer and may dissolve in the slurry. The solvent can be a aqueous based solvent comprising an organic based additive

The dispersant can include an alcohol such as t-butanol and/or a surfactant. The dispersant can be present in an amount from 0.5% to 1% by weight of the slurry. The solvent can be present in an amount of from 30% to 70% or from 30% to 50% by weight of the slurry. The slurry can be dried at a temperature of from 65′C to 120° C. The dried electrode body can be pressed to reduce its porosity to at least 30% or at least 40%.

Cells having a positive electrode and a negative electrode and an electrolyte in ionic communication with the positive and negative electrodes, wherein at least one of the positive and negative electrodes comprises an electrode as described herein are also disclosed.

The electrode systems disclosed herein can provide high specific energy and energy density and has extensive applications in energy storage systems.

### DESCRIPTION OF DRAWINGS

FIG. 1A is a schematic diagram showing the microstructure features of an exemplary electrode.

FIG. 1B is an image showing the microstructure obtained after tuning control parameters including binder, conductive additive, and amounts thereof.

FIG. 1C shows the performance improvement of the inventive cathodes compared to a prior art cathode.

FIG. 2 is a schematic diagram showing electrode compositions formulated by tuning different parameters including the active material, composite hinder, and conductive additives (all values in weight %).

FIG. 3 shows images of electrode designs of a conventional thin electrode vs an inventive thick electrode with crack channels.

FIG. 4 shows images of an electrode fabrication of a thick electrode obtained with PVdF binder and SBR/PAA binder.

FIG. 5 shows images of an electrode microstructure based on SBR/PAA under scanning electron microscope.

FIG. 6 shows images of electrode microstructures resulting from modifying the electrode composition of active material (A), binder (B) and carbon (C) from 85:7.5:7.5 to 72:10:18 to 60:10:30.

FIG. 7 shows graphs of the rate capability of PVdF and SBR/PAA based electrodes of different thicknesses.

FIG. 8 is a graph showing the rate capability of electrodes with different compositions for SBR/PAA binder.

### DETAILED DESCRIPTION

To improve the intrinsic capacity and transport properties of electrochemically active materials, microstructural features of electrodes are used to increase the volume fraction of active materials and reduce the length scale of ion transport through the electrolyte. Accordingly, the microstructures of components in such systems are tailored to optimize desirable properties and minimize the undesirable ones. Energy and power densities are typically influenced by system design, including, for example, component arrangement and selection, which is optimized for desirable performance.

Disclosed herein are electrode systems having improved power and energy densities for use in electrochemical devices. The electrochemical devices can be used as an energy storage system having a cathode and anode that are spaced apart from each other by spacer region, and an electrolyte. A carbonaceous conducting additive and an electrolyte material can be added to the energy storage material, lithium cobalt oxide, for example, to improve the electronic and ionic conductivity. Energy storage systems of the present disclosure include, but are not limited to lithium ion batteries, lithium-sulfur batteries, solid state batteries, fuel cells, and actuators. The energy storage systems can be based on liquid electrolytes. Batteries are typically constructed of solid electrodes, separators, electrolyte, and ancillary components such as, for example, packaging, thermal management, cell balancing, consolidation of electrical current carriers into terminals, and/or other such components. The electrodes typically include active materials, conductive materials, binders and other additives. For example, the typical lithium battery has a lithium foil or a composite carbon anode, a liquid electrolyte with a lithium salt and a composite cathode. In some embodiments, the disclosed electrode systems can be used as a composite cathode in lithium ion batteries. In some embodiments, the electrode systems can be used in a thin film battery in a bulk form wherein the electrode is a dense single phase material that has a plurality of channels filled with solid electrolyte. In some instances, the energy storage system can be based on solid-state battery technology.

Lithium batteries can be charged by applying a voltage between the electrodes, which causes lithium ions and electrons to be withdrawn from lithium hosts at the battery's cathode. Lithium ions flow from cathode to anode through electrolyte to be reduced at the anode. During discharge, the reverse occurs; lithium ions and electrons enter lithium hosts at cathode while lithium is oxidized to lithium ions at anode, which is typically an energetically favorable process that drives electrons through an external circuit, thereby supplying electrical power to a device to which the battery is connected. To improve operation, the electrode should provide fast transport for both electrons and lithium ions. During battery operation, for example, lithium ions pass through several steps to complete the electrochemical reaction. Typically, the steps include dissolution of lithium at the anode surface, which typically releases an electron to the external circuit; transport of the lithium ions through the electrolyte (which can reside in pores of a separator and, with porous electrodes, in the electrodes' pores); transport of the lithium ions through the electrolyte phase in a composite cathode, intercalation of lithium into the active cathode material, which typically receives electrons from the external circuit; and diffusion of lithium ions into the active material.

The transport of lithium through and its dissolution from the anode, its transport through the electrolyte and the intercalation reaction at the cathode-electrolyte interface, and the transport of lithium through the solid active material can be thermally activated and can be generally characterized by reaction kinetics. In some embodiments, the interface reactions, typically occurring at the electrode-electrolyte interface, are believed to be relatively fast at room temperature and, thus, not necessarily rate-limiting. Nevertheless, such reactions can be accelerated by increasing the surface area of the reaction and/or by reducing the particle size of the intercalation material. Since the diffusion (transport) of lithium through the electrolyte layer can be a rate-limiting step, the lithium ion transport between the opposite-polarity electrodes is generally facilitated by a decrease in the electrolyte layer thickness.

Ion transport in the electrolyte typically occurs in two regions, the separator region and the electrode region. In the former, generally, no electrochemical reactions occur and transport phenomena can be governed by the separator physical properties. The rate associated with this phenomenon can be reduced by designing or optimizing separator physical properties or by minimizing the transport distance across the separator. In the latter, ion transport can occur through the electrolyte-tilled pore channels or network structures of the electrode. The ion transport can be affected by, for example, the tortuosity of the average ion transport path. In some systems, the ionic current changes with electrode depth because of the electrochemical reaction.

As described herein, conventional electrodes for Li-ion batteries are prepared as thin layers (70-100 microns) to meet the power requirements of automotive applications. However, using thin electrodes compromises energy densities of battery cells due to increasing weight and volume of inactive components such as current collectors and a separator Thick (or 3D) electrodes have better active material utilization ratio and hence give better energy densities. Provided herein are electrode structures that favor or promote ion transport. For example, the present disclosure provides methods and systems that create vertical channels and improve the access of electrolytes in bulk of thick electrodes. The methods can be realized by producing channels and controlling the types and density of channels in the electrodes. The channels described herein may be in the form of a crack, fracture, or splitting that is at least partially propagated into the electrode body.

Particularly provided herein are electrodes for electrochemical devices comprising an electrode body having a first surface and second surface opposite the first surface, wherein the second surface of the electrode body is affixed to a current collector. The electrode body comprises a plurality of channels and wherein at least a portion of the channels extend from the first surface to the second surface of the electrode body. The electrode body can have an average thickness (distance from the first surface to the second surface opposite the first surface) of at least about 70 μm (for example, at least about 80 μm, at least about 90 μm, at least about 100 μm, at least about 150 μm, at least about 175 μm, at least about 200 μm, at least about 220 μm, at least about 240 μm, at least about 250 μm, at least about 280 μm, at least about 300 μm, at least about 320 μm, at least about 340 μm, at least about 350 μm, at least about 375 μm, at least about 400 μm, at least about 450 μm, or at least about 500 μm). In some embodiments, the electrode body can have an average thickness of 500 μm or less (for example, 475 μm or less, 450 μm or less, 420 μm or less, 400 μm or less, 380 μm or less, 360 μm or less, 350 μm or less, 340 μm or less, 320 μm or less, 300 μm or less, 280 μm or less, 260 μm or less, or 250 μm or less). In further embodiments, the electrode body can have an average thickness from 70 μm to 500 μm (for example, from 100 μm to 500 μm, from 150 μm to 500 μm, from 200 μm to 500 μm, from 210 μm to 500 μm, from 220 μm to 500 μm, from 150 μm to 400 μm, from 200 μm to 400 μm, from 150 μm to 350 μm, from 200 μm to 350 μm, or from 220 μm to 400 μm).

The size and density of the channels can be controlled during the methods of making the electrodes. In some embodiments, the channels can run through the entire thickness of the electrode body, from the first surface of the electrode body to the second surface of the electrode body affixed to the current collector. The channels can have an average length of at least about 10 μm (for example, at least about 20 μm, at least about 50 μm, at least about 70 μm, at least about 80 μm, at least about 90 μm, at least about 100 μm, at least about 150 μm, at least about 175 μm, at least about 200 μm, at least about 220 μm, at least about 240 μm, at least about 250 μm, at least about 280 μm, at least about 300 μm, at least about 320 μm, at least about 340 μm, at least about 350 μm, at least about 375 μm, at least about 400 μm, at least about 450 μm, or at least about 500 μm). In some embodiments, the channels can have an average length of 500 μm or less (for example, 475 μm or less, 450 μm or less, 420 μm or less, 400 μm or less, 380 μm or less, 360 μm or less, 350 μm or less, 340 μm or less, 320 μm or less, 300 μm or less, 280 μm or less, 260 μm or less, or 250 μm or less). In further embodiments, the channels can have an average length from 70 μm to 500 μm (for example, from about 70 μm to about 250 μm, from 100 μm to 500 μm, from 150 μm to 500 μm, from 200 μm to 500 μm, from 210 μm to 500 μm, from 220 μm to 500 μm, from 150 μm to 400 μm, from 200 μm to 400 μm, or from 220 μm to 400 μm).

The channels can have a variety of cross-sectional shapes such as, but not limited to circular, rectangular or polygonal. Some of the channels formed may propagate in parallel orientations, as in an example of cylindrical holes or cracks, extending through the electrode body. In some instances, the parallel oriented channels do not connect and remain reasonably isolated. In some embodiments, a channel network system can be formed. In the channel network system, the channels interconnect in the electrode body. In some embodiments, the channels can be partially or completely interconnected to one another. Channels can be interconnected through another channel or lateral cracks in the bulk of the electrode. The dimensions, cross-sectional shape, and cross-sectional area of the channels can vary widely, being selected to improve the transport characteristics of the electrochemical device while minimizing the total volume of porosity.

The channel volume (crack volume (C_{f})) in the electrode can vary, such as from 10% or greater, based on the volume of the electrode. In some embodiments, the channel volume can be at least about 10%, at least about 15%, at least about 20%, at least about 25%, at least about 30%, at least about 35%, at least about 40%, at least about 45%, at least about 50%, at least about 55%, or at least about 60%, based on the volume of the electrode. In some embodiments, the channel volume can be 60% or less, 55% or less, 50% or less, 45% or less, 40% or less, 35% or less, 30% or less, 25% or less, or 20% or less, based on the volume of the electrode. In further embodiments, the channel volume can be front 10% to 60% (for example, from 15% to 60%, from 20% to 60%, from 25% to 60%, from 30% to 60%, from 15% to 50%, from 20% to 50%, from 25% to 50%, from 30% to 50%, from 10% to 50%, from 10% to 45%, from 10% to 40%, from 10% to 35%, from 10% to 30%, or from 15% to 30%), based on the volume of the electrode.

The electrode structure having the channels can improve ionic diffusion by minimizing diffusion tortuosity. As the thickness of the electrode increases, these channels form a pathway for fast ionic transport leading to higher rate capability and homogeneous electrochemical reactions of active materials across the electrodes. Thus, the effective diffusion length can be decreased. By controlling the channel formation and channel density, optimum energy storage/battery performances can be achieved.

The electrodes may also comprise pores. The pores can have a porosity volume of 20% or greater, based on the volume of the electrode. In some embodiments, the porosity volume can be at least about 25%, at least about 30%, at least about 35%, at least about 40%, at least about 45%, at least about 50%, at least about 55%, or at least about 60%, based on the volume of the electrode. In some embodiments, the porosity volume can be 60% or less, 55% or less, 50% or less, 45% or less, 40% or less, 35% or less, 30% or less, 25% or less, or 20% or less, based on the volume of the electrode. In further embodiments, the porosity volume can be from 20% to 60% (for example, from 25% to 60%, from 30% to 60%, from 35% to 60%, from 40% to 60%, from 25% to 50%, from 30% to 50%, from 35% to 50%, from 40% to 50%, from 20% to 50%, from 20% to 45%, from 20% to 40%, from 20% to 35%, from 20% to 30%, or from 35% to 60%), based on the volume of the electrode.

A combination of binder chemistry, solid loading (amount of dry powders in water), dispersant, types of carbon network, substrate surface modification, and drying temperature and time can be used to control the channel size and density. Apart from creating channels, some other aspects of the electrodes described herein during electrode fabrication include maintaining good electrode stability during active material loading and porosity, improving interfacial contact between electrode slurry and current collector, enhancing carbon network (dispersion) for electronic conductivity within the thick electrode, optimizing binder chemistry and content for good adhesion between active material and carbon, which affects the porous structures in thick electrodes, and optimizing solvent properties in slurries using additives to control surface energies and volatilities.

Binder

As described herein, binder chemistry can be used to control the channel size and density as well as other important aspects of the electrodes. The binder used in the electrodes can be a solvent soluble polymer. The binder can be soluble in aqueous solvents (such as a water soluble polymer) or in other cases, soluble in organic solvents. The binder can include a conducting polymers that is also solvent soluble. Suitable conducting polymers can include polyacrylic acid (PAA), styrene-butadiene rubber (SBR), carboxylic acid and/or carboxylate polymers, polysaccharides, maleated polymers, fumarated polymers, ethylenically unsaturated acid polymers, carboxylated polyvinyl chloride, polyvinyl alcohol or copolymers with vinyl alcohol monomer units, polyundecylenol, copolymers of olefin and undecylenol, copolymers of olefin and undecylenic acid, ethylenically unsaturated alcohol polymers, phenoxy resins, cyclodextrin, hydroxypropyl cyclodextrin, hydroxyethyl cyclodextrin, copolymers thereof, crosspolymers thereof, alkali and/or alkaline earth metal salts thereof, esters thereof, or combinations thereof. Specific examples of binders include polyacrylic acid (PAA); styrene-butadiene rubber (SBR); alkali and/or alkaline earth salts of polymers and copolymers/crosspolymer of unsaturated carboxylic and/or carboxylate group, where the percent of alkali- and/or alkaline-ion exchange is 0-100%; alkali and/or alkaline earth salts of polysaccharides, where the percent of alkali- and/or alkaline-ion exchange is 0-100%; alkali and alkaline earth salts of maleated polymers and fumarated polymers and monoesters thereof; alkali and alkaline earth salts of polymers and copolymers of ethylenically unsaturated acids; alkali and alkaline earth salts of carboxylated polyvinyl chloride; alkali and alkaline earth salts of polyvinyl alcohol and copolymers with vinyl alcohol monomer units; alkali and alkaline earth salts of polyundecylenol and copolymers of olefins and undecylenol, polyundecylenic acid and copolymers of olefins and undecylenic acid; alkali and alkaline earth salts of maleated polymers and fumarated polymers and monoesters thereof; alkali and alkaline earth salts of homopolymers and copolymers of ethylenically unsaturated alcohols; alkali and alkaline earth salts of phenoxy resins; alkali and alkaline earth salts of cyclodextrins, hydroxypropyl cyclodextrins, and hydroxyethyl cyclodextrins; combinations thereof; and copolymers thereof.

In some examples, the binder can comprise a mixture of polyacrylic acid and styrene-butadiene rubber (SBR). The polyacrylic acid and styrene-butadiene rubber can be present in a weight ratio from 1:4 to 4:1, such as from 1:3 to 3:1, from 1:2 to 2:1, from 1:1 to 4:1 or from 2:1 to 4:1

In some embodiments, the binder does not comprise a fluoride-containing polymer.

The binder can be present in an amount of at least 3% by weight, based on the total weight of the electrode body. For example, the binder can be present in an amount of at least 5% by weight, at least 8% by weight, at least 10% by weight, at least 12% by weight, at least 15% by weight, at least 18% by weight, at least 20% by weight, at least 22% by weight, at least 25% by weight, at least 28% by weight, at least 30% by weight, at least 32% by weight, at least 35% by weight, at least 38% by weight, or at least 40% by weight, based on the total weight of the electrode body. In some embodiments, the binder can be present in an amount from 3 to 40% by weight, from 5 to 40% by weight, from 3 to 35% by weight, from 5 to 35% by weight, from 3 to 30% by weight, from 5 to 30% by weight, from 3 to 20% by weight, from 5 to 20% by weight, or from 10 to 20% by weight, based on the total weight of the electrode body.

Conductive Additive

The electrode can further comprise a conductive additive. The conductive additive can comprise one or more forms of carbons, such as carbon black, graphite, carbon nano-fiber, carbon micro-fiber, or a combination thereof. In some embodiments, the conductive additive can be sintered carbon, a mat of carbon fibers, a two-dimensionally or three-dimensionally woven carbon fiber, or a web of nanophase carbon or carbon nanorods, including fullerenic carbons and carbon nanotubes or nanofibers. The conductive additive can comprise more than one forms such as two or more forms of carbon.

The conductive additive can be present in an amount of at least 3% by weight, based on the total weight of the electrode body. For example, the conductive additive can be present in an amount of at least 4% by weight, at least 5% by weight, at least 6% by weight, at least 7% by weight, at least 8% by weight, at least 8% by weight, at least 10% by weight, at least 12% by weight, at least 15% by weight, at least 18% by weight, or at least 20% by weight, based on the total weight of the electrode body. In some embodiments, the conductive additive can be present in an amount from 3 to 20% by weight, from 5 to 20% by weight, from 5 to 15% by weight, from 3 to 12% by weight, from 3 to 10% by weight, or from 3 to 8% by weight, based on the total weight of the electrode body.

Electrolyte

The electrode comprises an electrolyte present in the plurality of channels. The electrolyte can include an organic material and an inorganic material selected to have sufficiently high lithium ionic conductivity and low electronic conductivity to act as an electrolyte. In some embodiments, the electrolyte can include, but is not limited to, one or more of the following, organic materials such as poly(ethylene oxide) (PEO), poly(styrene) (PS), polyacrylonitrile) (PAN), poly(vinylidene fluoride) (PVDF), diiodomethane, 1,3-diiodopropane, N,N-dimethylformamide (DMF), dimethyl propylene urea (DMPU), ethylene carbonate (EC), diethylene carbonate (DEC), dimethyl carbonate (DMC), propylene carbonate (PC), block copolymer lithium electrolytes, the preceding organic materials to be doped with a lithium salt such as LiClO₄, LiPF₆, LiAsF₆, LiCF₃SO₃ and LiBF₄ to provide lithium ionic conductivity or inorganic materials such as LiI, LiF, LiCl, Li₂O—B₂O₃—Bi₂O₃ compounds including glass, Li₂O—B₂O₃—P₂O₅ compounds including glass, Li₂O—B₂O₃—PbO compounds including glass, a sol or gel of the oxides or hydroxides of Ti, Zr, Pb, or Bi. In some embodiments, the electrolyte can comprise an alkali-salt dissolved in an organic/aqueous solvent, such as LiPF₆ in a mixture of linear carbonates or ring carbonates (e.g., ethylene carbonate, dimethyl carbonate, ethyl methyl carbonate, or diethyl carbonate). Specific examples of electrolytes can include 1-1.3 M LiPF₆ in the mixture of linear carbonates and ring carbonates such as ethylene carbonate, dimethyl carbonate, ethyl methyl carbonate, diethyl carbonate, or mixtures thereof.

As discussed herein, the plurality of channels are filled with electrolyte material, the electrode structure including the plurality of channels can improve ionic diffusion by minimizing diffusion tortuosity that is typical of prior art electrodes.

Current Collector

The electrode further comprises a current collector Various methods can be used to electrically connect an electrode network to a particular current collector. The anode and cathode can each be electrically connected to their own respective current collectors during or after fabrication of the electrode body. One way of achieving proper electrical connection uses an electrode slurry that can sufficiently wet the current collector. The current collector can be formed from a metal such as a metal toil or fine mesh. In some embodiments, the current collector can comprise Cu and/or Al, such as Cu or Al foils with or without carbon-coating. The current collector such as the Cu or Al foil preferably has a rough surface to enhance the adhesion of the electrode body.

Cells

Cells having a positive electrode and a negative electrode and an electrolyte in ionic communication with the positive and negative electrodes are also disclosed. At least one of the positive and negative electrodes can comprise an electrode as described herein.

In some embodiments, an electrochemical device comprising a cell as described herein has a power density of greater than 300 Wh/kg and an energy density of greater than 450 Wh/L for cells having a cell thickness less than 70 microns or greater, such as 200 microns or greater, wherein the cell thickness includes the collectors. In some embodiments, an electrochemical device has a power density of greater than 300 Wh/kg and an energy density of greater than 550 Wh/L (or greater than 700 Wh/L) cells having a cell thickness of 70 microns or greater, such as 200 microns or greater, wherein the cell thickness includes the collectors.

The electrodes described herein can exhibit a rate capability (area specific capability) of at least 2.2 mAh/cm², at least 3.3 mAh/cm², or at least 5.8 mAh/cm² at a C-rate of up to 1C.

Methods

Methods for manufacturing an electrode for an electrochemical device as disclosed herein are also provided. As described herein, a combination of binder chemistry, solid loading (amount of dry powders in water), dispersant, types of carbon network, substrate surface modification, and drying temperature and time can be used to control the channel (crack) density of the electrodes. The method for manufacturing the electrodes can include forming an electrode body by mixing an electroactive material, a conductive additive, a binder, a dispersant, and a solvent to form a slurry.

As disclosed herein, the electroactive material can vary depending on the specific electrochemical device. In some examples, the electrochemical device can be a lithium battery cell. In the lithium battery cell, the electroactive material can comprise lithium. The electrodes may comprise 50% by weight or greater of the electroactive material, based on the weight of the electrode. In some embodiments, the electroactive material can be present in an amount of at least about 55% by weight, at least about 60% by weight, at least about 65% by weight, at least about 70% by weight, at least about 75% by weight, at least about 78% by weight, at least about 80% by weight, at least about 83% by weight, at least about 85% by weight, at least about 87% by weight, at least about 90% by weight, or at least about 95% by weight, based on the weight of the electrode body. In some embodiments, the electroactive material can be 96% by weight or less, 95% by weight or less, 90% by weight or less, 87% by weight or less, 85% by weight or less, 83% by weight or less, 80% by weight or less, 75% by weight or less, 70% by weight or less, 65% by weight or less, 60% by weight or less, or 55% by weight or less, based on the weight of the electrode body. In further embodiments, the electroactive material can be from 50% to 96% by weight (for example, from 60% to 96% by weight, from 70% to 96% by weight, from 50% to 90% by weight, from 60% to 90% by weight, from 70% to 90% by weight, from 50% to 85% by weight, from 60% to 85% by weight, from 70% to 85% by weight, from 70% to 92% by weight, from 70% to 90% by weight, from 70% to 87% by weight, from 70% to 85% by weight, from 70% to 80% by weight, from 75% to 95% by weight, from 75% to 90% by weight, from 75% to 85% by weight, from 80% to 95% by weight, from 80% to 93% by weight, from 80% to 90% by weight) based on the weight of the electrode body. In some aspects, the electroactive material can be present in an amount of from 70% to 96% by weight of the dried electrode body

The electroactive material, the binder, and the conductive additive can be present in a weight ratio from 60-95:2.5-10:2.5-30, or in a weight ratio from 60-90:5-10:5-30, or in a weight ratio from 60-85:5-10:5-30.

As disclosed herein, the binder can comprise a solvent soluble polymer. The binders preferably and do not contain fluorine The binder, such as SBR can be used to give good dispersion and cracking characteristics. The amount of binder, such as SBR can be optimized to get the desired cracking while preventing capacity degradation. Some binders such as polyacrylic acid binder can act as a thickening agent.

Conventionally, N-methyl-2-pyrrolidone (NMP) is used as a solvent which is toxic and expensive to dispose. Water, however, has a higher surface tension compared to NMP, so the wetting of the current collector by electrode slurry is not as good. This leads to gaps/pockets at the interface causing electronic resistance. Improper surface adhesion or carbon network can be sources of impedances. To improve the dispersion and wetting characteristics of the slurry, a dispersant can be used as an additive in the electrode slurry. This reduces the surface tension of the slurry and decreases the volatility of the solvent. Electrodes thus obtained are stable mechanically, meaning it does not delaminate from the current collector surface.

In some embodiments, the solvent can be an aqueous based solvent comprising an organic based additive as a dispersant. The solvent is preferably water and can be present in an amount of from 30% to 70% by weight such as from 30% to 50% by weight of the slurry. The solvent, however, can be or include an organic solvent. The dispersant (organic additive) can be an alcohol such as t-butanol and/or a surfactant. The dispersant can be present in an amount of from 0.5% to 1% by weight of the slurry. Adding a dispersant such as tert-butanol also gives some control over crack formation.

The method of manufacturing the electrodes can further include depositing the slurry on a surface of a current collector and drying the slurry at an elevated temperature for a sufficient time to induce formation of a plurality of channels in the electrode body. The slurry can be dried at any suitable temperature, such as from 65° C. to 150° C. or from 65° C. to 120° C. In some examples, the slurry can be dried in a stepwise manner, such as the slurry is dried initially at from 65° C. to 100° C., followed by drying at from greater than 100° C. to 130° C.

The channel (or crack) density can be quantified using image processing of SEM images of the electrode after electrochemical cycling. As disclosed herein, crack formation enables easier electrolyte penetration into the bulk of the electrode for enhanced Li ion transport. The crack density can be correlated to the performance of the thick electrode.

Following drying, the dried electrode body can be pressed to reduce its porosity, such as reduced to less than 60%, less than 50%, 40% or less, or as described herein.

The electrode systems disclosed herein can provide specific energy (>300 Wh/kg) and energy density (>700 Wh/L) and has extensive applications in electric vehicles and grid connected energy storage systems The electrodes have improved power compared to batteries of conventional design, because the ion diffusion distance can be decreased. In a conventional laminated battery design in which the thicknesses of the positive and negative electrodes are approximately uniform, during charging or discharging the ions must diffuse across the thickness of the electrodes. In most conventional lithium ion device, the rate of transport of lithium ions across the electrode thickness limits the power. The transport rate of electrons is believed to be much higher and is not necessarily rate-limiting in the currently disclosed systems. Further, increased interfacial area between the electrode and electrolyte is achieved.

The stored energy or charge capacity of conventional batteries is typically a function of: (1) the inherent charge capacity of the active material (mAh/g), (2) the volume of the electrodes (cm³) (i.e., the product of the electrode thickness, electrode area, and number of layers (stacks)), and (3) the loading of active material in the electrode media (e.g., grams of active material per cm³ of electrode media). Therefore, to enhance commercial appeal (e.g., increased energy density and decreased cost), it is generally desirable to increase the areal charge capacity (mAh/cm²) also referred to as “area specific capacity” or “area capacity” herein. The areal charge capacity can be increased, for example, by utilizing active materials that have a higher inherent charge capacity, increasing relative percentage of active charge storing material (i.e., “loading”) in the overall electrode formulation, and/or increasing the relative percentage of electrode material used in any given battery form factor. Said another way, increasing the ratio of active charge storing components (e.g., the electrodes) to inactive components (e.g., the separators and current collectors), increases the overall energy density of the battery by eliminating or reducing components that are not contributing to the overall performance of the battery. One way to accomplish increasing the areal charge capacity, and therefore reducing, the relative percentage of inactive components, is by increasing the thickness of the electrodes.

Conventional electrode compositions have capacities of approximately 150-200 mAh/g and generally cannot be made thicker than about 100 μmm because of certain performance and manufacturing limitations. For example, i) conventional electrodes having a thickness over 100 μm (single sided coated thickness) typically have significant reductions in their rate capability due to diffusion limitations through the thickness of the electrode (e.g. porosity, tortuosity, impedance, etc.) which grows rapidly with increasing thickness; ii) thick conventional electrodes are difficult to manufacture due to drying and post processing limitations, for example, solvent removal rate, capillary forces during drying that leads to cracking of the electrode, poor adhesion of the electrode to the current collector leading to delamination (e.g., during the high speed roll-to-roll calendering process used for manufacturing conventional electrodes), migration of binder during the solvent removal process and/or deformation during a subsequent compression process; iii) without being bound to any particular theory, the binders used in conventional electrodes may obstruct the pore structure of the electrodes and increase the resistance to diffusion of ions by reducing the available volume of pores and increasing tortuosity (i.e. effective path length) by occupying a significant fraction of the space between the functional components of the electrodes (i.e. active and conductive components). It is also known that binders used in conventional electrodes can at least partially coat the surface of the electrode active materials, which slows down or completely blocks the flow of ions to the active materials, thereby increasing tortuosity.

Furthermore, known conventional batteries either have high capacity or high rate capability, but not both. A battery having a first charge capacity at first C-rate, for example, 0.5 C generally has a second lower charge capacity when discharged at a second higher C-rate, for example, 2 C. This is due to the higher energy loss that occurs inside a conventional battery due to the high internal resistance of conventional electrodes, and a drop in voltage that causes the battery to reach the low-end voltage cut-off sooner. The theoretical area specific capacity can hypothetically be increased without limit by increasing the thickness of the electrode and/or by increasing the volume fraction of the active material in the electrode. However, such arbitrary increases in theoretical area specific capacity are not useful if the capacity cannot be used at a practical C-rate. Increases in area specific capacity that cannot be accessed at practical C-rates are highly detrimental to battery performance. The capacity appears as unused mass and volume rather than contributing to stored energy, thereby lowering the energy density and area specific capacity of the battery. Moreover, a thicker electrode generally has a higher internal resistance and therefore a lower rate capability. For example, a lead acid battery does not perform, well at 1 C C-rate. They are often rated at a 0.2 C C-rate and even at this low C-rate, they cannot attain 100% capacity. In contrast, ultracapacitors can be discharged at an extremely high C-rate and still, maintain 100% capacity, however, they have a much lower capacity than conventional batteries. Accordingly, a need exists for batteries with thicker electrodes, but without the aforementioned limitations.

The electrodes described herein can be made thicker due to the channels and can be operated between a wide range of C-rates while maintaining a substantial portion of its charge capacity. The channels results in superior rate capability and charge capacity of electrochemical cells formed from the electrodes. In some examples, the electrodes herein exhibit a rate capability (area specific capability) of at least 2.2 mAh/cm², at least 3.3 mAh/cm², or at least 5.8 mAh/cm² at a C-rate of up to 1C.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods in addition to those shown and described herein are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated

### EXAMPLES

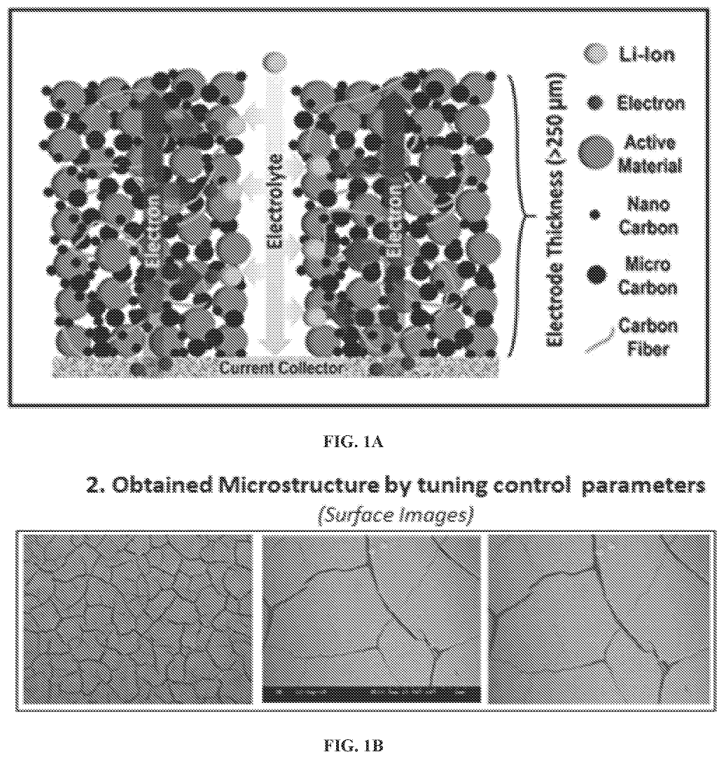

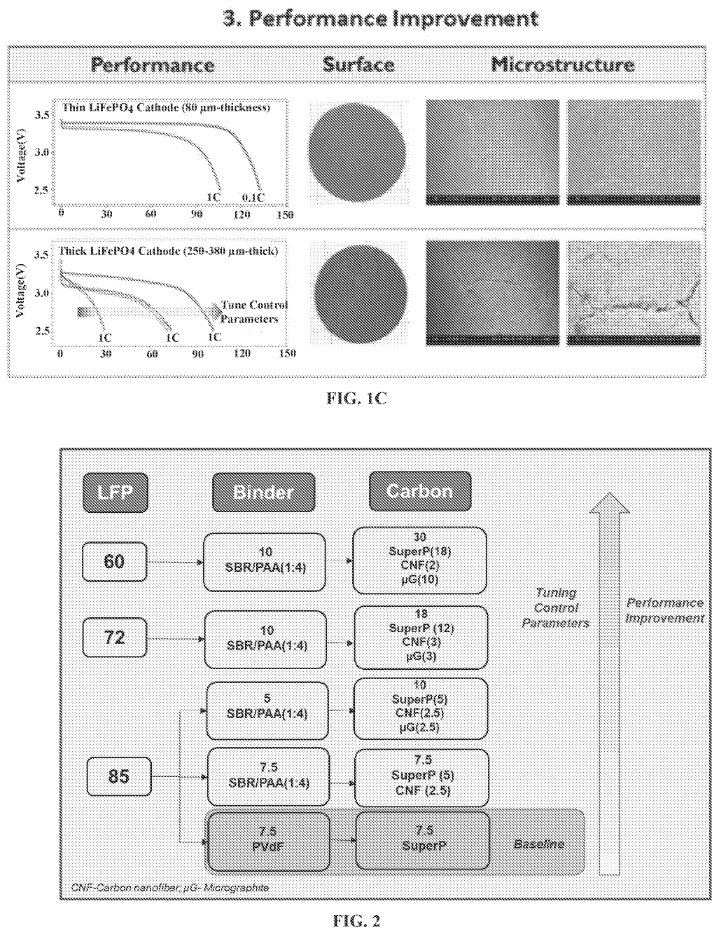

FIG. 1 is a schematic diagram showing the microstructure features of an exemplary electrode.

Systematic studies were conducted to understand the improvement over baseline thick electrode performance. The baseline discussed here refers to the LFP thick electrode made with PVdF binder having similar thickness, loading and porosity Electrode compositions formulated by tuning different parameters are as shown in FIG. 2 (all values in wt. %).

Cathodes comprising LiFePO₄(LFP) as the active material; styrene butadiene rubber(SBR) and poly acrylic acid (PAA) as the composite binder; and SuperP, carbon nanofiber (CNF) and micro graphite (μG) as the conductive additives in different ratios combined as described in FIG. 2 were prepared. The amount of solvent used was shown to be important to control the viscosity and ensure homogenous mixing. Excess solvent increases surface tension thereby impacting the adhesion. For 1 g of materials, 2.5 ml of solvent was used. The slurry was prepared by adding these materials in different stages in a speed mixer (Thinky USA) at 1000 rpm for 1 min. Firstly, the binders were added to water and thoroughly mixed. Then the conductive additives were introduced followed by active material in the final stage. The slurry was then applied onto an aluminum foil current collector (MTI) using a slurry coater and a doctor blade (thickness set to 1200 μm). The slurry cast Al-foil was dried at 353K for 30 min in a convention oven and then at 393 K for 12 h in a vacuum oven (Across Intl.). The coated cathode foil was then pressed through stainless-steel twin rollers (MTI Corp.) to reduce the porosity to ˜40%. Electrodes were then cut into circular discs 13.7 mm in diameter using an electrode punch (Hohsen).

FIG. 1B shows an image of the microstructure obtained after tuning the several control parameters. FIG. 1C shows the performance improvement of the inventive cathodes compared to a prior art cathode.

Method For Preparing High-Energy Electrodes with Controlled Microstructures for Electrochemical Devices

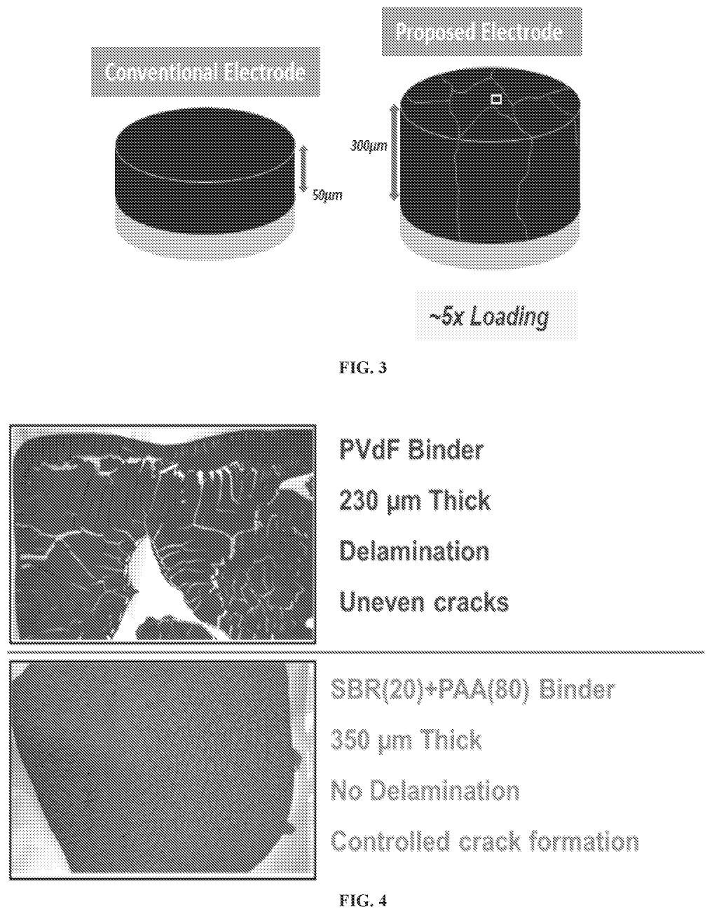

In this example, electrodes for electrochemical devices and methods of making the electrodes are provided. The electrodes include an electrode body comprising a plurality of channels wherein at least a portion of the channels extend from the first surface to the second surface of the electrode body. The channels extending from the first surface to the second surface of the electrode body can be a single continuous channel or a plurality of channels that network to form an ‘opening’ (channel) from the first surface to the second surface of the electrode body. As described herein, in the methods of making the electrodes, a combination of binder chemistry, solid loading, dispersant, types of carbon network, substrate surface modification, and drying temperature and time can be used to control the channel size and density. FIG. 3 shows exemplary electrode designs of conventional thin electrode vs an inventive thick electrode with crack channels.

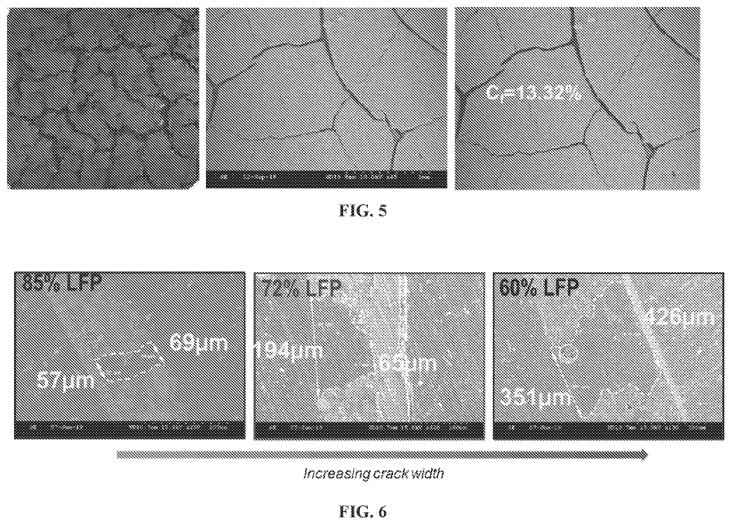

FIG. 4 shows images of electrode fabrication of thick electrodes obtained with PVdF binder and SBR/PAA binder. PVdF based thick electrodes show non-uniform cracking and severe delamination from substrate. The crack formation occurs due to increasing thickness rather than binder interactions. Whereas the SBR/PAA binder combination shows better adhesion to the substrate and a more homogenous crack formation. This was observed for a higher thickness than PVdF based electrode.

The SBR/PAA based electrode was observed under scanning electron microscope for better understanding of the microstructure. The electrodes were calendared to a porosity of 40%.

The image shows interconnected crack patterns that run from the surface through the bulk of the electrode. FIG. 5 is an image analysis of an inventive electrode microstructure showing that the fraction of crack volume (Cr) is about 13.32%.

By changing the electrode composition of active material (A), binder (B) and carbon (C) the crack patterns were modified in a controlled manner This behavior was observed in the SBR/PAA binder but not the PVdF binder. FIG. 6 shows images obtained from tuning electrode composition to modify microstructure. By changing the composition (A:B:C) from 85:7.5:7.5 to 72:10:18 to 60:10:30, the crack width increased along with better carbon network.

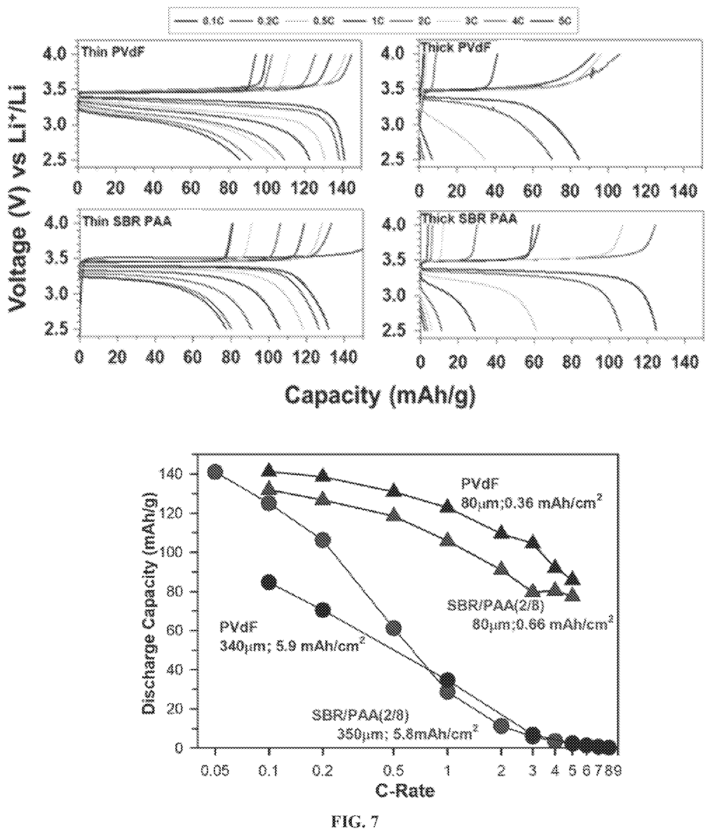

FIG. 7 include graphs showing the rate capability of PVdF and SBR/PAA based electrodes of different thicknesses. The figure shows voltage profiles (V vs mAh/g) and C-rate discharge capacities of different binder chemistries. The thin SBR/PAA electrode shows lower impedance as seen from the gap between charge and discharge curves on the voltage profile. The discharge capacity follows the same trend as PVdF electrode. For the thick electrode, the SBR/PAA electrode shows significantly higher capacity than PVdF electrode until 1C rate beyond which the electronic conductivity is a limiting factor to see any improvement in performance.

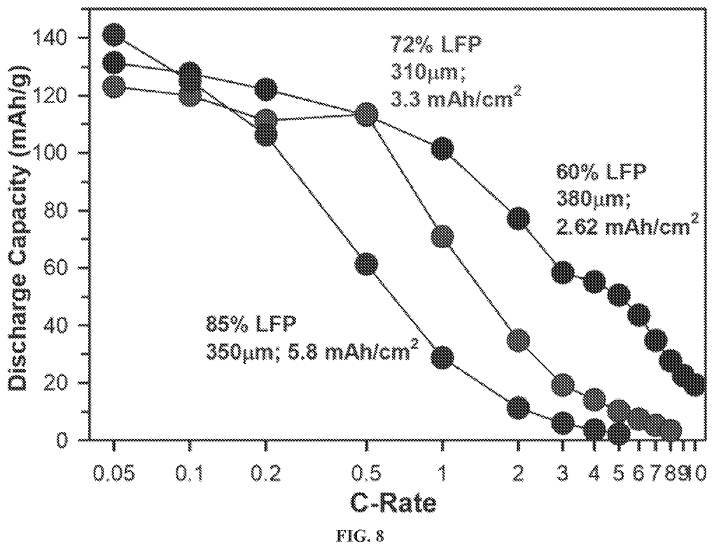

FIG. 8 shows the rate capability of electrodes with different compositions for SBR/PAA binder. Keeping the binder chemistry the same and tuning the electrode composition gave different microstructures. It also led to an improvement in performance especially at higher C-rates. This is attributed to increased channel width and also better carbon network.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, ail numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. An electrode for an electrochemical device comprising:
an electrode body having a first surface and second surface opposite the first surface,
wherein the second surface of the electrode body is affixed to a current collector,
wherein the electrode body comprises a plurality of channels and wherein at least a portion of the channels extend from the first surface to the second surface of the electrode body, and
wherein the electrode body has an average thickness (distance from the first surface to the second surface of the electrode body) of at least about 70 μm.

2. The electrode of claim 1, wherein the electrochemical device is an energy storage device such as a lithium-ion battery, a lithium-sulfur battery, a solid state battery, a fuel cell, or an actuator, preferably the electrochemical device is a lithium-ion battery.

3. The electrode of claim 1, wherein the electrode body has an average thickness of at least about 200 μm, from about 200 μm to about 500 μm, or from about 200 μm to about 400 μm.

4. The electrode of claim 1, wherein at least a portion of the channels has an average length of at least about 10 μm, at least about 100 μm, at least about 200 μm, from about 10 μm to about 500 μm, or from about 50 μm to about 500 μm.

5. The electrode of claim 1, wherein a portion of the plurality of channels are isolated from each other.

6. The electrode of claim 1, wherein a portion of the plurality of channels are interconnected.

7. The electrode of claim 1, wherein the plurality of channels are present in an amount (crack volume (Cf)) of 10 vol % or greater, based on the volume of the electrode.

8. The electrode of claim 1, wherein the electrode body further comprises pores, wherein the pores have a porosity volume of 30% or greater, 35% or greater, 40% or greater, from 20% to 60%, or from 30% to 40%, based on the volume of the electrode.

9. The electrode of claim 1, wherein the electrode body further comprises a solid binder.

10. (canceled)

11. The electrode of claim 9, wherein the binder comprises a conducting polymer such as polyacrylic acid (PAA), styrene-butadiene rubber (SBR), carboxylic acid and/or carboxylate polymers, polysaccharides, maleated polymers, fumarated polymers, ethylenically unsaturated acid polymers, carboxylated polyvinyl chloride, polyvinyl alcohol or copolymers with vinyl alcohol monomer units, polyundecylenol, copolymers of olefin and undecylenol, copolymers of olefin and undecylenic acid, ethylenically unsaturated alcohol polymers, phenoxy resins, cyclodextrin, hydroxypropyl cyclodextrin, hydroxyethyl cyclodextrin, copolymers thereof, crosspolymers thereof, alkali and/or alkaline earth metal salts thereof, or esters thereof.

12. The electrode of claim 9, wherein the binder comprises polyacrylic acid and styrene-butadiene rubber (SBR) in a weight ratio from 1:4 to 4:1.

13. The electrode of claim 1, wherein the electrode body further comprises a conductive additive.

14. (canceled)

15. The electrode of claim 1, further comprising an electroactive material comprising lithium.

16. The electrode of claim 15, wherein the electroactive material is present in an amount of from 50% to 96% by weight or from 60% to 85% by weight of the electrode body.

17. The electrode of claim 1, wherein the electroactive material, the binder, and conductive additive are present in a weight ratio 60-95:2.5-10:2.5-30.

18. The electrode of claim 1, wherein the electrode body comprises an electrolyte, wherein the electrolyte is present in the plurality of channels.

19. (canceled)

20. The electrode of claim 1, wherein the current collector is a metal current collector.

21. (canceled)

22. The electrode of claim 1, wherein the electrode has a rate capability (area specific capability) of at least 2.2 mAh/cm2, at least 3.3 mAh/cm2, or at least 5.8 mAh/cm2 at a C-rate of up to 1C.

23. A cell having a positive electrode and a negative electrode and an electrolyte in ionic communication with the positive and negative electrodes, wherein at least one of the positive and negative electrodes comprises an electrode according to claim 1.

24. A method for manufacturing an electrode for an electrochemical device comprising:
a) forming an electrode body by mixing an electroactive material, a conductive additive, a binder, a dispersant, and a solvent to form a slurry,
wherein the binder comprises a solvent soluble polymer, and
wherein the solvent is an aqueous based solvent comprising an organic based additive;
b) depositing the slurry on a surface of a current collector; and
c) drying the slurry at an elevated temperature for a sufficient time to induce formation of a plurality of channels in the electrode body, and wherein at least a portion of the channels extend from a first surface of the electrode body to a second surface opposite the first surface of the electrode body.

25-42. (canceled)
